(19) United States
(12) Patent Application Publication
(10) Pub. No.: US 2026/0155455 A1
(43) Pub. Date: Jun. 4, 2026

(54) SOLID-STATE BATTERY

(71) Applicant: Murata Manufacturing Co., Ltd., Nagaokakyo-shi (JP)

(72) Inventor: Yusuke FUNADA, Nagaokakyo-shi (JP)

(21) Appl. No.: 19/457,235

(22) Filed: Jan. 23, 2026

Related U.S. Application Data
(63) Continuation of application No. PCT/JP2024/027571, filed on Aug. 1, 2024.

(30) Foreign Application Priority Data
Aug. 2, 2023 (JP) 2023-126503

(51) Int. Cl. H01M 10/0585; H01M 4/02; H01M 4/131; H01M 4/525; H01M 4/62; H01M 10/0525; H01M 10/0562; H01M 10/42; H01M 50/548; H01M 50/562

(52) U.S. Cl. CPC H01M 10/0585; H01M 4/131; H01M 4/525; H01M 4/62; H01M 10/0525; H01M 10/0562; H01M 10/4235; H01M 50/548; H01M 50/562; H01M 2004/028; H01M 2300/0071

(57) ABSTRACT

A solid-state battery including: a battery element including: a positive electrode including a positive electrode active material part, and a negative electrode; a positive external terminal in contact with the positive electrode; and a negative external terminal in contact with the negative electrode, wherein the battery element further includes a first electrode enclosure part surrounding a portion other than a first contact portion between the positive external terminal and the positive electrode, at least the positive electrode contains a first solid electrolyte containing lithium and halogen, the first electrode enclosure part includes at least a first region interposed between the positive electrode and the negative external terminal, the first region contains lithium and a second solid electrolyte containing halogen or not containing halogen, and an element ratio (%) of halogen to the lithium of the second solid electrolyte in the first region is 0% to 6%.

### CROSS REFERENCE TO RELATED APPLICATIONS

The present application is a continuation of International application No. PCT/JP2024/027571, filed Aug. 1, 2024, which claims priority to Japanese Patent Application No. 2023-126503, filed Aug. 2, 2023, the entire contents of each of which are incorporated herein by reference.

### TECHNICAL FIELD

The present disclosure relates to a solid-state battery.

### BACKGROUND ART

Conventionally, a secondary battery that can be repeatedly charged and discharged has been used for various applications. For example, secondary batteries are used as power supplies for electronic devices such as smart phones and notebook computers.

In the secondary batteries, liquid electrolytes (electrolytic solutions) such as organic solvents have been conventionally used as media for moving ions. The secondary batteries with the electrolytic solutions used have, however, problems such as leakages of the electrolytic solutions. Therefore, the development of solid-state batteries including a solid electrolyte instead of a liquid electrolyte has been advanced.
Patent Document 1: Japanese Patent Application Laid-Open No. 2020-71902

### SUMMARY OF THE DISCLOSURE

As a conventional solid-state battery, there is mentioned a solid-state battery including: a battery element including a positive electrode, a negative electrode, and a solid electrolyte part interposed between the positive electrode and the negative electrode; and an external terminal provided so as to be in contact with each of the positive electrode and the negative electrode of the battery element. In such a conventional solid-state battery, the battery element includes an electrode enclosure part (it may also be referred to as a margin layer or a side margin layer) surrounding a portion other than a contact portion with the external terminal in each of the positive electrode and the negative electrode in plan view, and the external terminal may contain a metal component.

In the conventional solid-state battery, in order to reduce the battery resistance, a solid electrolyte having a high degree of ionic conductivity can be introduced into the constituent elements of the battery element. In order to improve the degree of ionic conductivity of such a solid electrolyte, a halogen element may be introduced into the solid electrolyte (see Patent Document 1).

In the conventional solid-state battery, when the external terminal may contain a metal component and the solid electrolyte in the electrode enclosure part and the electrode active material part (particularly, a positive electrode active material part having a high potential) of the battery element may contain a halogen element, the inventors of the present application have found that the following problem may occur. Specifically, in the process of, for example, repeatedly charging and discharging the battery in a high-temperature atmosphere, the metal component of the external terminal on the negative electrode side is ionized, and the ionized metal component moves to the positive electrode active material part side by taking the halogen element contained in the solid electrolyte as a trigger, and as a result, a short circuit may occur in the solid-state battery.

The present disclosure has been made in view of such circumstances. That is, an object of the present disclosure is to provide a solid-state battery capable of reducing the occurrence of short circuit even when charging and discharging are repeated.

To achieve the above object, in one embodiment of the present disclosure, there is provided a solid-state battery including: a battery element including: a positive electrode including a positive electrode active material part; a negative electrode including a negative electrode active material part; a solid electrolyte part interposed between the positive electrode and the negative electrode; and a positive external terminal in contact with the positive electrode; and a negative external terminal in contact with the negative electrode, wherein the battery element further includes: a first electrode enclosure part surrounding a portion other than a first contact portion between the positive external terminal and the positive electrode in a plan view as viewed from a thickness direction of the battery element; and a second electrode enclosure part surrounding a portion other than a second contact portion between the negative external terminal and the negative electrode in the plan view as viewed from the thickness direction of the battery element, the negative external terminal contains a metal component, at least the positive electrode contains a first solid electrolyte containing lithium and halogen, the first electrode enclosure part includes at least a first region interposed between the positive electrode and the negative external terminal, the first region contains lithium and a second solid electrolyte containing halogen or not containing halogen, and an element ratio (%) of halogen to the lithium of the second solid electrolyte in the first region is 0% to 6%, the positive electrode includes a first outer edge facing away from the negative external terminal with the first region interposed therebetween, (i) in the plan view, the first region has a first length longer than ¼ of a separation distance between the negative external terminal and the first outer edge of the positive electrode active material part in a first direction between the positive external terminal and the negative external terminal, and has a second length equal to a length of the battery element in a second direction intersecting the first direction, and/or (ii) in the plan view, the first region is in contact with at least the first outer edge of the positive electrode active material part in the first direction, and has a second length longer than a length of the first outer edge of the positive electrode active material part in the second direction.

According to the solid-state battery according to the embodiment of the present disclosure, it is possible to reduce the occurrence of short circuit even when charging and discharging are repeated.

### BRIEF EXPLANATION OF THE DRAWINGS

FIG. 1A is a perspective view schematically illustrating a solid-state battery according to an embodiment of the present disclosure.

FIG. 1B is a schematic sectional view of the solid-state battery according to the embodiment taken along line X-X in FIG. 1A.

FIG. 1C is a schematic plan view of the positive electrode of the solid-state battery according to the embodiment of FIG. 1B as viewed from a thickness direction of a battery element.

FIG. 1D is a schematic plan view of the negative electrode of the solid-state battery according to the embodiment of FIG. 1B as viewed from the thickness direction of the battery element.

FIG. 2A is a schematic plan view of a positive electrode of a solid-state battery according to another embodiment as viewed from a thickness direction of a battery element.

FIG. 2B is a schematic plan view of a positive electrode of a solid-state battery according to another embodiment as viewed from a thickness direction of a battery element.

FIG. 3 is a schematic plan view of a positive electrode of a solid-state battery according to still another embodiment as viewed from a thickness direction of a battery element.

FIG. 4 is a schematic plan view of a positive electrode of a solid-state battery according to still another embodiment as viewed from a thickness direction of a battery element.

FIG. 5 is a schematic plan view of a positive electrode of a solid-state battery according to still another embodiment as viewed from a thickness direction of a battery element.

FIG. 6 is a schematic plan view of a positive electrode of a solid-state battery according to still another embodiment as viewed from a thickness direction of a battery element.

FIG. 7 is a schematic plan view of a positive electrode of a solid-state battery (comparative example) as viewed from a thickness direction of a battery element.

FIG. 8 is a schematic plan view of a positive electrode of a solid-state battery (comparative example) as viewed from a thickness direction of a battery element.

FIG. 9 is a schematic plan view of a positive electrode of a solid-state battery (comparative example) as viewed from a thickness direction of a battery element.

### DESCRIPTION OF THE PREFERRED EMBODIMENTS

Before describing a solid-state battery according to an embodiment of the present disclosure, the basic configuration of the solid-state battery will be described. The term “solid-state battery” used in the present specification refers, in a broad sense, to a battery that has constituent elements composed of solids, and in a narrow sense, to an all-solid-state battery that has constituent elements (in particular, all constituent elements) composed of solids. According to a preferred aspect, a solid-state battery according to the present disclosure is a stacked solid-state battery configured such that respective layers constituting a battery constituent unit are stacked on each other, and preferably, such layers are each composed of a sintered body. The “solid-state battery” used in the present specification can encompass not only a secondary battery that can be repeatedly charged and discharged, but also a primary battery that can be only discharged. According to a preferred aspect of the present disclosure, the solid-state battery is a secondary battery. The “secondary battery” is not to be considered excessively restricted by its name, which can encompass, for example, a power storage device and the like.

The term “sectional view” used in the present specification refers to a solid-state battery as viewed from a direction substantially perpendicular to a thickness direction based on the stacking direction of material layers constituting the solid-state battery. The “vertical direction” and “horizontal direction” used directly or indirectly in the present description correspond to a vertical direction and a horizontal direction in the drawings, respectively. Unless otherwise specified, the same reference signs or symbols shall denote the same members or sites or the same meanings. According to a preferred aspect, it can be understood that a downward direction in a vertical direction (that is, a direction in which gravity acts) corresponds to a “downward direction”, whereas the opposite direction corresponds to an “upward direction”.

The various numerical ranges mentioned in the present specification are intended to include the lower and upper numerical values themselves, unless otherwise stated. Specifically, for example, taking a numerical range “1 to 10” as an example, unless otherwise described, it is interpreted that the numerical range includes the lower limit “1” and also includes the upper limit “10”.

### [Configuration of Solid-State Battery]

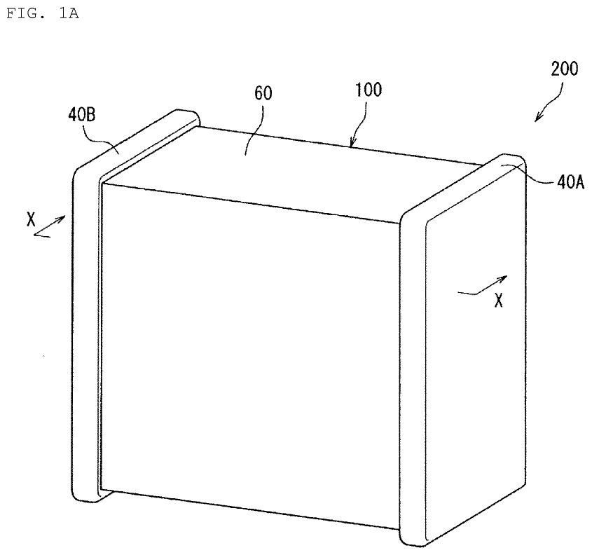

FIG. 1A is a perspective view schematically illustrating a solid-state battery according to an embodiment of the present disclosure. FIG. 1B is a schematic sectional view of the solid-state battery according to the embodiment taken along line X-X in FIG. 1A. The solid-state battery includes at least electrodes of a positive electrode and a negative electrode, and a solid electrolyte. FIG. 1C is a schematic plan view of the positive electrode of the solid-state battery according to the embodiment of FIG. 1B as viewed from a thickness direction of a battery element. FIG. 1D is a schematic plan view of the negative electrode of the solid-state battery according to the embodiment of FIG. 1B as viewed from the thickness direction of the battery element.

As illustrated in FIGS. 1A and 1B, a solid-state battery 200 includes a solid-state battery laminate 100 (corresponding to a battery element) including a battery constituent unit composed of a positive electrode including a positive electrode active material part 10A, a negative electrode including a negative electrode active material part 10B, and a solid electrolyte part 20 at least interposed between the electrodes.

Specifically, the solid-state battery 200 according to the present disclosure includes: the solid-state battery laminate 100 including, in a stacking direction L, at least one battery constituent unit composed of a positive electrode, a negative electrode, and a solid electrolyte part 20 interposed between the electrodes; and an external terminal 40A on the positive electrode side and an external terminal 40B on the negative electrode side each provided on facing end surfaces of the solid-state battery laminate 100. In the solid-state battery laminate 100, the positive electrode and the negative electrode are alternately stacked with the solid electrolyte part 20 interposed therebetween.

For the solid-state battery, each of the layers constituting the solid-state battery may be formed by firing, and the positive electrode, the negative electrode, the solid electrolyte part, and the like may form fired layers. Preferably, the positive electrode, the negative electrode, and the solid electrolyte part are each fired integrally with each other, and the solid-state battery laminate preferably forms an integrally fired body.

The positive electrode active material part contains at least a positive electrode active material. The positive electrode active material part may further contain a solid electrolyte. In a preferred aspect, the positive electrode active material part is composed of a fired body including at least positive electrode active material particles and solid electrolyte particles. On the other hand, the negative electrode active material part contains at least a negative electrode active material. The negative electrode active material part may further contain a solid electrolyte. In a preferred aspect, the negative electrode active material part is composed of a sintered body including at least negative electrode active material particles and solid electrolyte particles.

The positive electrode active material and the negative electrode active material are substances involved in the transfer of electrons in the solid-state battery. Ions move (conduct) between the positive electrode active material part and the negative electrode active material part with the solid electrolyte interposed therebetween, and electrons are transferred, and thereby the charging and discharging are performed. Each electrode active material part of the positive electrode active material part and the negative electrode active material part is preferably a layer capable of storing and releasing lithium ions or sodium ions, in particular. More specifically, the solid-state battery is preferably an all-solid-state secondary battery in which lithium ions or sodium ions move between the positive electrode and the negative electrode through the solid electrolyte, thereby charging and discharging the battery.

### (Positive Electrode Active Material)

Examples of the positive electrode active material contained in the positive electrode active material part include at least one selected from the group consisting of a lithium-containing phosphate compound having a NASICON-type structure, a lithium-containing phosphate compound having an olivine-type structure, a lithium-containing layered oxide, and a lithium-containing oxide having a spinel-type structure. One example of the lithium-containing phosphate compound having a NASICON-type structure includes Li₃V₂(PO₄)₃. Examples of the lithium-containing phosphate compound having an olivine-type structure include LiFePO₄ and LiMnPO₄. Examples of the lithium-containing layered oxide include LiCoO₂ and LiCo_{1/3}Ni_{1/3}Mn_{1/3}O₂. Examples of the lithium-containing oxide having a spinel-type structure include LiMn₂O₄ and LiNi_{0.5}Mn_{1.5}O₄.

Examples of the positive electrode active material capable of storing and releasing sodium ions include at least one selected from the group consisting of a sodium-containing phosphate compound having a NASICON-type structure, a sodium-containing phosphate compound having an olivine-type structure, a sodium-containing layered oxide, a sodium-containing oxide having a spinel-type structure, and the like.

### (Negative Electrode Active Material)

Examples of the negative electrode active material contained in the negative electrode active material part include at least one selected from the group consisting of oxides containing at least one element selected from the group consisting of Ti, Si, Sn, Cr, Fe, Nb, and Mo, a graphite-lithium compound, a lithium alloy, a lithium-containing phosphate compound having a NASICON-type structure, a lithium-containing phosphate compound having an olivine-type structure, and a lithium-containing oxide having a spinel-type structure. Examples of the lithium alloy include Li—Al. Examples of the lithium-containing phosphate compound having a NASICON-type structure include Li₃V₂(PO₄)₃ and LiTi₂(PO₄)₃. Examples of the lithium-containing phosphate compound having an olivine-type structure include LiCuPO₄. Examples of the lithium-containing oxide having a spinel-type structure include Li₄Ti₅O₁₂.

Examples of the negative electrode active material capable of storing and releasing sodium ions include at least one selected from the group consisting of a sodium-containing phosphate compound having a NASICON-type structure, a sodium-containing oxide having a spinel-type structure, and the like.

Note that, in the solid-state battery of the present disclosure according to a preferred aspect, the positive electrode and the negative electrode are made of the same material.

The positive electrode active material part and/or the negative electrode active material part may contain a conductive aid. Examples of the conductive aid contained in the positive electrode active material part and the negative electrode active material part include at least one kind of metal materials such as silver, palladium, gold, platinum, aluminum, copper, and nickel, and carbon. Although not particularly limited, carbon is preferred in that carbon hardly reacts with the positive electrode active material, the negative electrode active material, the solid electrolyte material, or the like, and produces the effect of reducing the internal resistance of the solid-state battery.

The positive electrode and/or the negative electrode may include a sintering aid. Examples of the sintering aid include at least one selected from the group consisting of a lithium oxide, a sodium oxide, a potassium oxide, a boron oxide, a silicon oxide, a bismuth oxide, and a phosphorus oxide.

The thicknesses of the positive electrode and negative electrode are not particularly limited, and may be, independently of each other, for example, 2 μm to 50 μm, particularly 5 μm to 30 μm.

### (Positive Electrode Current Collector/Negative Electrode Current Collector)

Although not an essential element for the electrode, the positive electrode and the negative electrode may respectively include a positive electrode current collector and a negative electrode current collector. The positive electrode current collector and the negative electrode current collector may each have the form of a foil. The positive electrode current collector and the negative electrode current collector may each have, however, the form of a fired body, if more importance is placed on viewpoints such as improving the electron conductivity, reducing the manufacturing cost of the solid-state battery, and/or reducing the internal resistance of the solid-state battery, which are obtained by integral firing.

As the positive electrode current collector constituting the positive electrode current collector and the negative electrode current collector constituting the negative electrode current collector, it is preferable to use a material with a high conductivity, and for example, silver, palladium, gold, platinum, aluminum, copper, nickel, and/or a carbon material may be used. The positive electrode current collector and the negative electrode current collector may each have an electrical connection for being electrically connected to the outside, and may be configured to be electrically connectable to a terminal.

Note that, when the positive electrode current collector and the negative electrode current collector have the form of a fired body, the current collectors may be composed of a fired body containing a conductive material and a sintering aid. The conductive materials contained in the positive electrode current collector and the negative electrode current collector may be selected from, for example, the same materials as the conductive materials that can be contained in the positive electrode and the negative electrode. The sintering aid contained in each of the positive electrode current collector and the negative electrode current collector is selected from, for example, the same material as the sintering aid that can be contained in each of the positive electrode and the negative electrode.

### (Solid Electrolyte)

The solid electrolyte is a material capable of conducting lithium ions or sodium ions. In particular, the solid electrolyte constituting the battery constituent unit in the solid-state battery is a layer through which lithium ions can conduct between the positive electrode and the negative electrode. Specific examples of the solid electrolyte include a lithium-containing phosphate compound having a NASICON structure, an oxide having a perovskite structure, an oxide having a garnet-type or garnet-type similar structure, an oxide glass ceramic-based lithium ion conductor, a sulfide glass ceramic-based lithium ion conductor, an oxide-based glass material, and a sulfide-based glass material. As an example of an oxide having an amorphous structure, one having a composition in which halogen such as Cl or Br is contained as an additive in a glassy substance composed of Li, B, Si, and O can be used.

Examples of the lithium-containing phosphate compound having a NASICON structure include LiₓM_{y}(PO₄)₃(1≤x≤2, 1≤y≤2, M is at least one selected from the group consisting of Ti, Ge, Al, Ga, and Zr). Examples of the lithium-containing phosphate compound having a NASICON structure include Li_{1.2}Al_{0.2}Ti_{1.8}(PO₄)₃. Examples of the oxide having a perovskite structure include La_{0.55}Li_{0.35}TiO₃. Examples of the oxide having a garnet-type or garnet-type similar structure include Li₇La₃Zr₂O₁₂. Examples of the oxide glass ceramic-based lithium ion conductor include a phosphate compound (LATP) containing lithium, aluminum, and titanium as constituent elements, and a phosphate compound (LAGP) containing lithium, aluminum, and germanium as constituent elements. Examples of the sulfide-based glass ceramic-based lithium ion conductor include Li₇P₃S₁₁ and Li_{3.25}P_{0.95}S₄.

Examples of the oxide-based glass material include 50Li₄SiO₄-50Li₃BO₃. Examples of the sulfide-based glass material include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and 50Li₂S-50GeS₂.

When more emphasis is placed on the viewpoint of achieving excellent atmospheric stability and easy integral sintering, the solid electrolyte may contain at least one selected from the group consisting of an oxide, an oxide glass ceramic-based lithium ion conductor, and an oxide-based glass material.

Examples of the solid electrolyte capable of conducting sodium ions include a sodium-containing phosphate compound having a NASICON structure, an oxide having a perovskite structure, and an oxide having a garnet-type or garnet-type similar structure. Examples of the sodium-containing phosphate compound having a NASICON structure include NaₓM_{y}(PO₄)₃(1≤x≤2, 1≤y≤2, and M is at least one selected from the group consisting of Ti, Ge, Al, Ga, and Zr).

The solid electrolyte may include a sintering aid. The sintering aid included in the solid electrolyte may be selected from, for example, the same materials as the sintering aids, which can be included in the positive electrode or the negative electrode.

The thickness of the solid electrolyte part is not particularly limited. The thickness of the solid electrolyte part located between the positive electrode and the negative electrode may be, for example, 1 μm to 15 μm, particularly 1 μm to 5 μm.

### (Electrode Enclosure Part)

As illustrated in FIGS. 1B to 1D, in the present disclosure, in plan view as viewed from the thickness direction of the battery element, the battery element may further include electrode enclosure parts (also referred to as electrode separating parts, margin layers, or margin parts) 30A and 30B surrounding portions other than a contact portion with the external terminal in each of the positive electrode active material part 10A and the negative electrode active material part 10B.

The electrode enclosure part (also referred to as a positive electrode enclosure part) 30A on the positive electrode side is disposed around the positive electrode active material part 10A, thereby separating the positive electrode active material part 10A from the external terminal 40B on the negative electrode side. The electrode enclosure part 30B on the negative electrode side (also referred to as a negative electrode enclosure part) is disposed around the negative electrode active material part 10B, thereby separating the negative electrode active material part 10B from the external terminal 40A on the positive electrode side.

Although not particularly limited, the electrode enclosure parts 30A and 30B may be composed of, for example, one or more materials selected from the group consisting of a solid electrolyte, an insulating material, a mixture thereof, and the like. For the solid electrolyte that can constitute the electrode enclosure parts 30A and 30B, the same material as the solid electrolyte that can constitute the solid electrolyte part 20 can be used.

The insulating material that can constitute the electrode enclosure parts 30A and 30B may be a material that does not conduct electricity, that is, a non-conductive material. Although not particularly limited, the insulating material may be, for example, a glass material, a ceramic material, or the like. For example, a glass material may be selected as the insulating material. The glass material is not particularly limited, and examples of the glass material include at least one selected from the group consisting of soda-lime glass, potash glass, borate-based glass, borosilicate-based glass, barium-borosilicate-based glass, borate subsalt-based glass, barium-borate-based glass, bismuth-borosilicate-based glass, bismuth-zinc-borate-based glass, bismuth-silicate-based glass, phosphate-based glass, aluminophosphate-based glass, and phosphate subsalt-based glass. The ceramic material is not particularly limited, but examples thereof include at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃).

### (External Terminal)

As described above, the solid-state battery 200 of the present disclosure is generally provided with the external terminal 40A on the positive electrode side and the external terminal 40B on the negative electrode side. In particular, the external terminals 40A and 40B for positive and negative electrodes are provided so as to form a pair on end surfaces (corresponding to side surfaces) of the solid-state battery. The external terminals 40A and 40B can be provided so as to cover at least one end surface of the solid-state battery, and thus, can be referred to as “end face electrodes”.

The external terminal 40A on the positive electrode side can be in contact with the positive electrode active material part or the positive electrode current collector, and the external terminal 40B on the negative electrode side can be in contact with the negative electrode active material part or the negative electrode current collector. That is, the external terminals on the positive electrode side and the negative electrode side can be in contact with the positive electrode and the negative electrode, respectively. For example, the external terminal on the positive electrode side is configured to be joinable to an end of the positive electrode active material part, specifically, an extended part formed at the end of the positive electrode active material part. The external terminal on the negative electrode side is configured to be joinable to an end of the negative electrode active material part, specifically, an extended part formed at the end of the negative electrode active material part.

For the external terminals 40A and 40B, materials with a high conductivity can be used. The material of the external terminal 40 is not particularly limited, and examples thereof include at least one conductive material selected from the group consisting of silver, gold, platinum, aluminum, copper, tin, and nickel.

The external terminals 40A and 40B may further contain a sintering aid. Examples of the sintering aid include the same materials as the sintering aid that may be contained in the positive electrode active material part 10A and/or the negative electrode active material part 10B. In a preferred aspect, the external terminals 40A and 40B are composed of a sintered body containing at least a conductive material and a sintering aid.

In a preferred aspect, from the viewpoint of joining the external terminal to the extended part of the electrode active material part, the external terminal is preferably formed by thermally curing a resin paste containing a conductive material. The external terminals preferably contain a material with a high conductivity. A specific material for the external terminal is not particularly limited, but examples thereof may include at least one selected from the group consisting of silver, gold, platinum, aluminum, copper, tin, and nickel. The use of a metal material for the external terminal materials can suppress entry of moisture from the external terminals. The thickness of the external terminal is not particularly limited, and may be, for example, 0.01 μm to 1 mm, particularly 1 μm to 100 μm.

### (Exterior Body)

The solid-state battery 200 of the present disclosure typically further includes an exterior body 60. The exterior body 60 can be generally formed on the outermost side of the solid-state battery, and is a layer covering the surface of the battery element so that the extended part of each electrode active material part and each external terminal can be joined to each other. The exterior body 60 covers the surface of the battery element so that the extended part of the positive electrode active material part and the external terminal on the positive electrode side can be joined, and covers the surface of the battery element so that the extended part of the negative electrode active material part and the external terminal on the negative electrode side can be joined.

The exterior body 60 is provided for electrical, physical, and/or chemical protection. The material constituting the exterior body 60 is preferably excellent in insulation property, durability, and/or moisture resistance, and environmentally safe. For example, glass, ceramics, thermosetting resins, photocurable resins, mixtures thereof, and the like can be used.

As glass that can constitute the exterior body, the same material as the glass material that can constitute the electrode enclosure parts can be used. As a ceramic material that can constitute the exterior body, the same material as the ceramic material that can constitute the electrode enclosure parts can be used.

### Characteristic Parts of Present Disclosure

Hereinafter, characteristic parts of the present disclosure will be described (see, in particular, FIGS. 1B and 1C). Note that, in the present disclosure, it is assumed that while the external terminal may contain the metal component described above, at least the electrode active material part (particularly, the positive electrode active material part having a high potential) of the battery element may contain a halogen element.

Under such a premise, the inventors of the present application have extensively conducted studies on a configuration of a solid-state battery capable of reducing occurrence of short circuit even when charging and discharging are repeated. As a result, the inventors of the present application have found that there is a magnitude relationship in halogen amount between a solid electrolyte, which is contained in a predetermined region (hereinafter, referred to as a first region 31A) of the electrode enclosure part 30A on the positive electrode side located between the positive electrode active material part 10A and the external terminal 40B on the negative electrode side, and a solid electrolyte, which is contained at least in the positive electrode active material part 10A.

Specifically, the present disclosure describes (i) reducing the amount of halogen in the solid electrolyte contained in the first region 31A of the electrode enclosure part 30A on the positive electrode side located between the external terminal 40B on the negative electrode side and the positive electrode active material part 10A, and (ii) setting the range occupied by the first region 31A to a predetermined range.

More specifically, in one embodiment, firstly, at least the positive electrode active material part 10A contains a first solid electrolyte containing lithium and halogen, and at least the first region 31A of the electrode enclosure part 30A on the positive electrode side contains lithium and a second solid electrolyte containing halogen or not containing halogen.

The first solid electrolyte can be included not only in the positive electrode but also in the negative electrode and the solid electrolyte part 20 (see FIG. 1A). In one example, each of the first solid electrolyte and the second solid electrolyte is an oxide glass-based solid electrolyte. As an example of the oxide glass-based solid electrolyte, one containing lithium borosilicate glass as a main component can be selected.

Note that, in plan view as viewed from the thickness direction of the battery element (see FIG. 1C), the electrode enclosure part 30A on the positive electrode side may include a second region 32A in addition to the first region 31A described above. This second region 32A is continuous with the first region 31A and contains a first solid electrolyte (not a second solid electrolyte). On the other hand, although not particularly limited, the electrode enclosure part 30B on the negative electrode side may have a configuration containing a first solid electrolyte (not a second solid electrolyte) as a whole in plan view (see FIG. 1D).

In this case, the element ratio of halogen to lithium of the second solid electrolyte in the first region 31A of the electrode enclosure part 30A on the positive electrode side is 0% to 6%. In one example, the element ratio (%) of halogen to lithium contained in the second solid electrolyte contained in the first region 31A of at least the electrode enclosure part 30A is 0% to 3%, and may be preferably 0% to 1.3%, more preferably 0% to 0.6%. With the limitation of such a range, it is possible to further reduce the occurrence of short circuit in the solid-state battery even when the number of charge/discharge cycles of the solid-state battery is increased.

In plan view (see FIG. 1C), the positive electrode active material part 10A may have a rectangular shape. In this case, the positive electrode active material part 10A includes a first outer edge 11A facing away from the external terminal 40B on the negative electrode side with the first region 31A interposed therebetween, a second outer edge 12A continuous with the first outer edge 11A and extending in a direction intersecting an extending direction of the first outer edge 11A, a third outer edge 13A facing the second outer edge 12A, and a fourth outer edge 14A facing the first outer edge 11A and in contact with the external terminal 40A on the positive electrode side.

In a first embodiment, in plan view (see FIG. 1C), the first region 31A is in contact with at least the first outer edge 11A of the positive electrode active material part 10A in a first direction X between the external terminals on the positive electrode side and on the negative electrode side, and has a second length L2 longer than a length of the first outer edge 11A of the positive electrode active material part 10A in a second direction Y intersecting the first direction X.

Here, when charging and discharging are repeated in a high-temperature atmosphere, the ionized metal component moves to the positive electrode active material part side by taking the halogen element contained in the solid electrolyte as a trigger, that is, ion migration occurs, and as a result, a short circuit may occur in the solid-state battery.

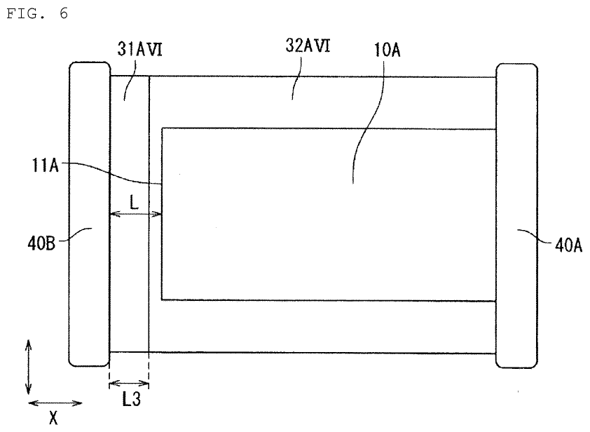

In this regard, when the above characteristics are satisfied, the content of halogen with respect to lithium of the second solid electrolyte contained in the first region 31A is a predetermined value or less. In addition thereto, the first region 31A is in contact with at least the first outer edge 11A of the positive electrode active material part 10A in the first direction X. As compared with an embodiment illustrated in FIG. 7 (an embodiment in which a first region 31A′ has a second length L2′ shorter than the length of a first outer edge 11A′ of a positive electrode active material part 10A′), since the first region 31A has the second length L2 longer than the length of the first outer edge 11A of the positive electrode active material part 10A in the second direction Y, the range occupied by the first region 31A is set to a range in which ionized metal ions are less likely to enter the inside of the positive electrode active material part 10A from the external terminal 40B on the negative electrode side.

Note that, from the viewpoint of making it more difficult for ionized metal ions to enter the inside of the positive electrode active material part 10A in the first direction X from the external terminal 40B on the negative electrode side, in plan view, the first region 31A preferably has a first length L1 equal to a separation distance L between the external terminal 40B on the negative electrode side and the first outer edge 11A of the positive electrode active material part (see FIG. 1C).

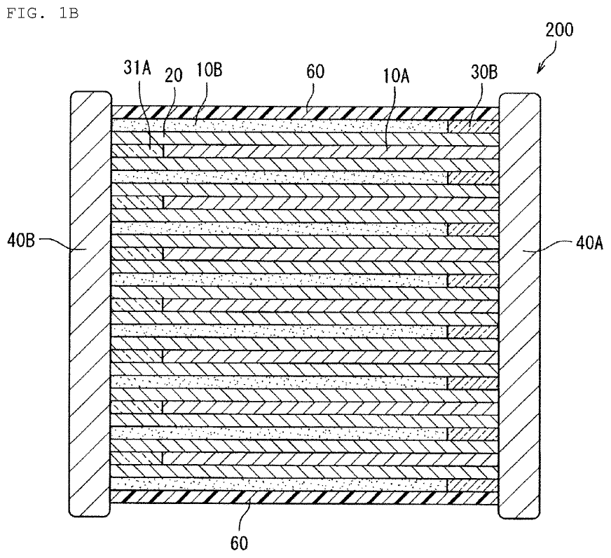

From the viewpoint of making it more difficult for ionized metal ions to enter the inside of the positive electrode active material part 10A from the external terminal 40B on the negative electrode side, in plan view, the second length L2 of the first region 31AI is more preferably equal to the length of the battery element (corresponding to the solid-state battery laminate 100) in the second direction Y (see FIG. 2A) as compared with the embodiment of FIG. 1C. From the same viewpoint, it is still more preferable that a first region 31AII of the electrode enclosure part faces the second outer edge 12A and the third outer edge 13A in addition to the first outer edge 11A (see FIG. 2B).

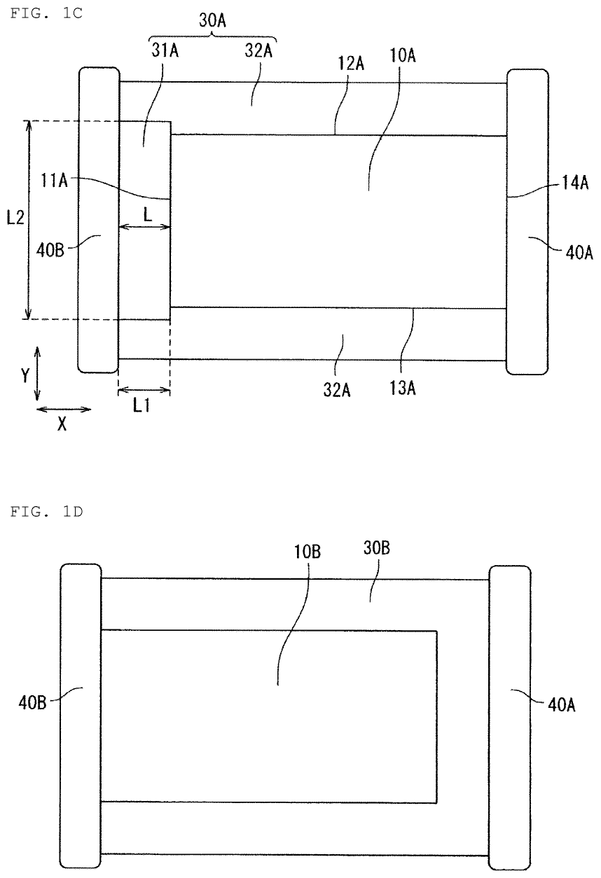

Hereinafter, a second embodiment will be described below. In the second embodiment, the characteristics of the element ratio of halogen to lithium of the second solid electrolyte in a first region 31AIII of the electrode enclosure part on the positive electrode side are the same as those in the first embodiment. On the other hand, in the second embodiment, unlike the first embodiment, in plan view (see FIG. 3), the first region 31AIII has a first length L3 longer than ¼ of the separation distance L between the external terminal 40B on the negative electrode side and the first outer edge 11A of the positive electrode active material part in the first direction X, and has a second length L4 equal to the length of a battery element 100III in the second direction Y intersecting the first direction X.

Also in this case, the content of halogen with respect to lithium in the second solid electrolyte contained in the first region 31AIII of the electrode enclosure part 30A on the positive electrode side located between the external terminal 40B on the negative electrode side and the positive electrode active material part 10A is a predetermined value or less. In addition thereto, since the first region 31AIII has the second length L4 equal to the length of the battery element 100III in the second direction Y, the range occupied by the first region 31AIII is set to a range in which ionized metal ions are less likely to enter the inside of the positive electrode active material part 10A from the external terminal 40B on the negative electrode side.

As described above, in both of the first and second embodiments, ion migration from the external terminal 40B side on the negative electrode side to the positive electrode active material part 10A side is suppressed, and direct contact between ionized metal ions of the external terminal 40B on the negative electrode side and the positive electrode active material part 10A can be suppressed. As a result, the occurrence of short circuit in the solid-state battery 200 can be suitably reduced as compared with a case where the above characteristics are not satisfied. That is, in the present disclosure, the first region of the electrode enclosure part on the positive electrode side can function as a prevention region of ion migration of the metal component of the external terminal toward the positive electrode active material part.

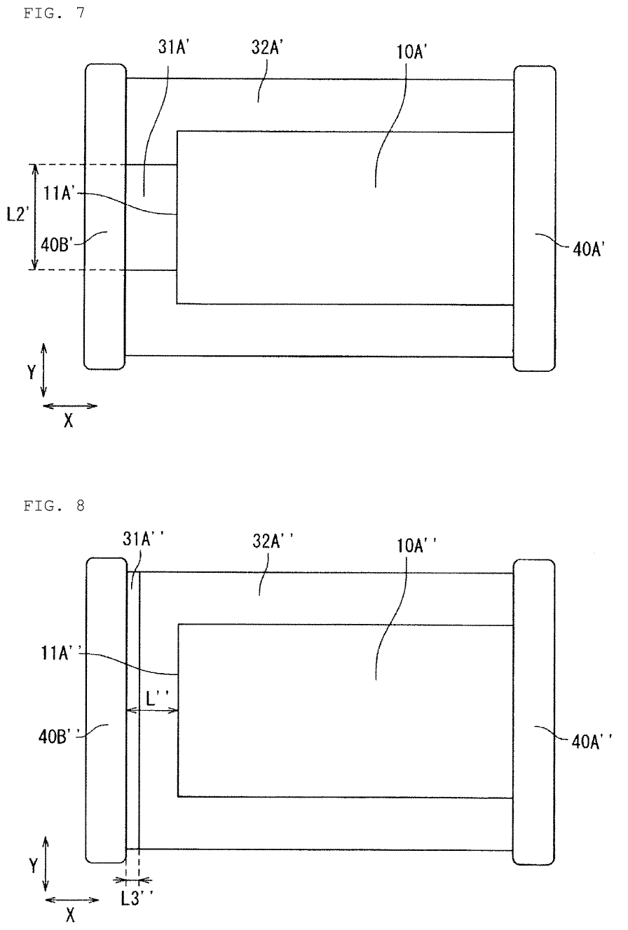

Note that, in the second embodiment, when the first length L3 of the first region is longer than ¼ of the separation distance L between the external terminal 40B on the negative electrode side and the first outer edge 11A of the positive electrode active material part in the first direction X, the arrangement place of the first region can be positioned at any place between the external terminal 40B on the negative electrode side and the first outer edge 11A of the positive electrode active material part. Note that, in any of the following embodiments, since the width of the first region in the first direction X can be secured as compared with the embodiment illustrated in FIG. 8 (an embodiment in which a first length L3″ of a first region 31A″ is shorter than ¼ of a separation distance L″ between an external terminal 40B″ on the negative electrode side and an first outer edge 11A″ of the positive electrode active material part in the first direction X), the first region can be made equal to or larger than a predetermined size.

In one example, the first region 31AIII can be disposed so as to be contactable with the external terminal 40B on the negative electrode side (see FIG. 3). When the first region 31AIII can be in contact with the external terminal 40B on the negative electrode side, it is possible to make it difficult for ionized metal ions to enter on an interface region side between the external terminal 40B on the negative electrode side and the electrode enclosure part on the positive electrode side, the interface region being an entry start point of the metal ions from the external terminal 40B on the negative electrode side to the battery element side when charging and discharging of the battery are repeated.

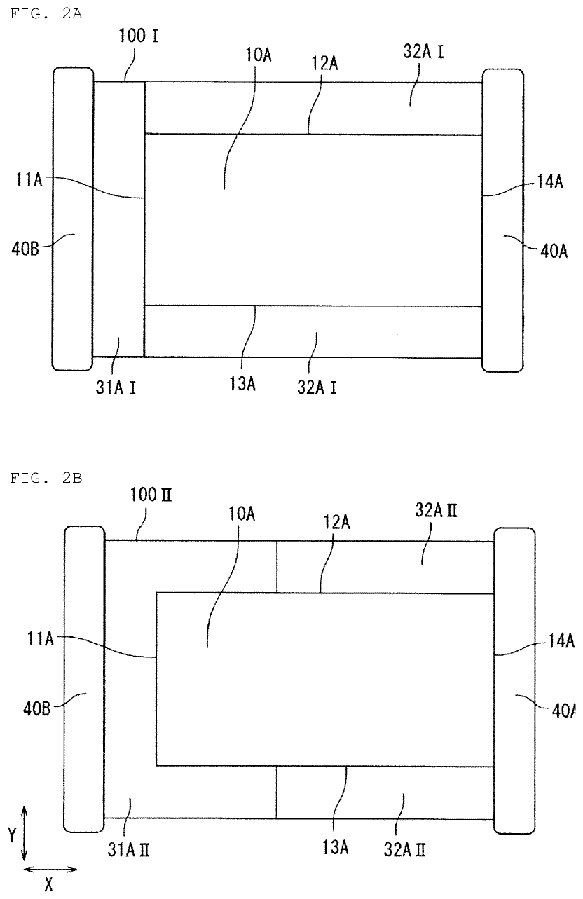

In another example, a first region 31AIV may be disposed separately from the external terminal 40B on the negative electrode side and the first outer edge 11A of the positive electrode active material part (see FIG. 4). Also in such an arrangement, since the first region 31AIV has the second length L4 equal to the length of a battery element 100IV in the second direction Y, it is possible to make it difficult for ionized metal ions to enter the inside of the positive electrode active material part 10A from the external terminal 40B on the negative electrode side in the first region 31AIV.

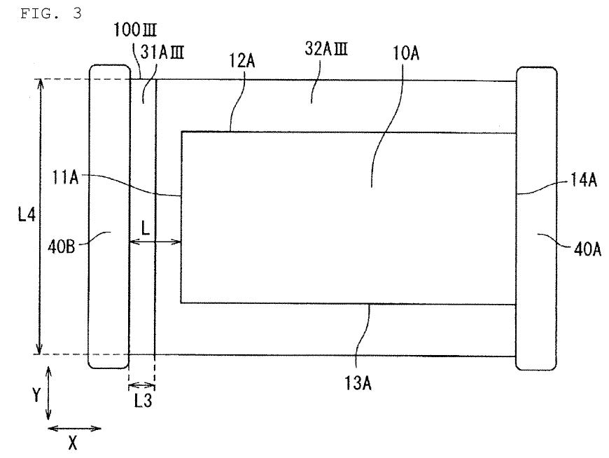

In another example, a first region 31AV can be disposed so as to be contactable with the first outer edge 11A of the positive electrode active material part (see FIG. 5). When the first region 31AV can be in contact with the first outer edge 11A of the positive electrode active material part, as compared with the embodiment illustrated in FIG. 8, it is possible to make it difficult for ionized metal ions to enter on an interface region side between the first outer edge 11A of the positive electrode active material part and the electrode enclosure part on the positive electrode side, the interface region being an entry start point of the metal ions of the external terminal 40B on the negative electrode side to the positive electrode active material part 10A when charging and discharging of the battery are repeated.

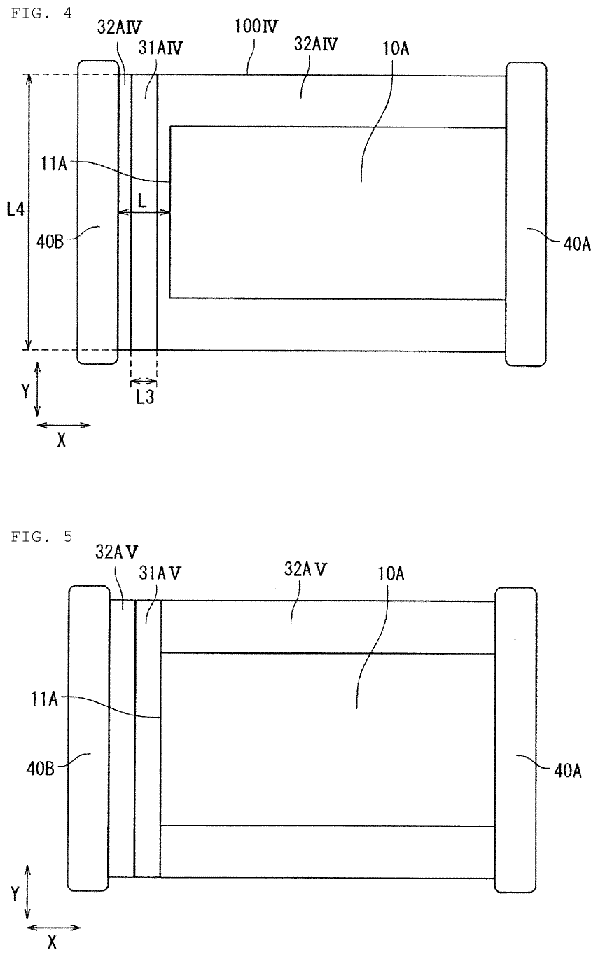

In still another example, as compared with the embodiment of FIG. 3, a first region 31AVI can be in contact with the external terminal 40B on the negative electrode side and the first length L3 of the first region 31AVI may be ¾ of the separation distance L between the external terminal 40B on the negative electrode side and the first outer edge 11A of the positive electrode active material part in the first direction X (see FIG. 6). In this case, as compared with the embodiment of FIG. 3, since the first length L3 of the first region 31AVI is increased and the size of the first region 31AVI is increased, It is possible to make it more difficult for ionized metal ions to enter the inside of the positive electrode active material part 10A from the external terminal 40B on the negative electrode side in the first direction X.

In the second embodiment, as can be seen from the embodiments illustrated in FIGS. 3 and 5, in plan view, the first region of the electrode enclosure part can be in contact with at least one of the positive electrode active material part and the external terminal on the negative electrode side. Preferably, from the viewpoint of further increasing the size of the first region to make it more difficult for the ionized metal component of the external terminal 40B on the negative electrode side to enter the inside of the positive electrode active material part in the first direction X, the first region of the electrode enclosure part is preferably configured to be contactable with both the positive electrode active material part and the external terminal on the negative electrode side. In this case, the first region of the electrode enclosure part is more preferably continuous from the external terminal on the negative electrode side to the positive electrode active material part.

### [Method for Manufacturing Solid-State Battery]

A method for manufacturing the solid-state battery according to an embodiment of the present disclosure will be described below. The solid-state battery according to the present disclosure can be manufactured by a printing method such as a screen printing method, a green sheet method in which green sheets are used, or a combined method thereof. Hereinafter, a case where the printing method and the green sheet method are employed for understanding the present disclosure will be described in detail, but the present disclosure is not limited to the methods. More specifically, the solid-state battery may be manufactured in accordance with a common method for manufacturing a solid-state battery. The following time-dependent matters such as the order of descriptions are merely considered for convenience of explanation, and the present disclosure is not necessarily bound by the matters.

### (Step of Forming Solid-State Battery Laminate Precursor)

In this step, for example, several types of pastes such as a paste for a positive electrode active material part, a paste for a negative electrode active material part, a paste for a solid electrolyte part, a paste for an electrode enclosure part, and a paste for an exterior body are applied by printing and are dried to form a solid-state battery laminate precursor having a predetermined structure on a supporting substrate. The paste for a positive electrode current collector and a paste for a negative electrode current collector are not necessarily required, but are optionally prepared.

In printing, a solid-state battery laminate precursor corresponding to the structure of a predetermined solid-state battery can be formed on a substrate by sequentially stacking printing layers that each have a predetermined thickness and a pattern shape. The type of the pattern forming method is not particularly limited as long as the method is a method capable of forming a predetermined pattern, and is, for example, any one or two or more of a screen printing method, a gravure printing method, and the like.

The paste can be prepared by wet mixing of predetermined constituent materials for each of the layers, appropriately selected from the group consisting of positive electrode active material particles, negative electrode active material particles, a conductive material, a solid electrolyte material, a current collector material, an insulating material, a sintering aid, and the other materials mentioned above with an organic vehicle in which an organic material is dissolved in a solvent. Here, in the present disclosure, as described later, a first solid electrolyte containing halogen is used as a solid electrolyte material used at least in a paste for a positive electrode active material part. The present disclosure is not limited thereto, and a first solid electrolyte containing halogen can be used in some of a paste for a negative electrode active material part, a paste for a solid electrolyte part, and a paste for an electrode enclosure part, which will be described later, and the like.

The paste for a positive electrode active material part contains, for example, positive electrode active material particles, a first solid electrolyte, an organic material, a solvent, and a sintering aid as desired.

The paste for a negative electrode active material part contains, for example, negative electrode active material particles, first solid electrolyte, an organic material, a solvent, and a sintering aid as desired.

The paste for a solid electrolyte part contains, for example, a first solid electrolyte, an organic material, a solvent, and a sintering aid as desired.

The paste for a positive electrode current collector to be optionally prepared contains a conductive material, a first solid electrolyte, a material, a solvent, and a sintering aid as desired.

The paste for a negative electrode current collector to be optionally prepared contains a conductive material, a first solid electrolyte, an organic material, a solvent, and a sintering aid as desired.

The paste for an electrode enclosure part contains, for example, a solid electrolyte material, an insulating material, an organic material, a solvent, and a sintering aid as desired. In the present disclosure, two types of pastes for an electrode enclosure part are prepared. As a first paste, one containing a second solid electrolyte is used, and as a second paste, one containing a first solid electrolyte is used.

Specifically, as the second solid electrolyte, one having an element ratio of halogen to lithium of 0% to 6% is selected. As an example, one containing lithium borosilicate glass as a main component can be used as a solid electrolyte. In this case, one obtained by substituting a predetermined ratio of the total contained oxygen with halogen (for example, Cl, Br, or the like) is used.

The paste for an exterior body contains, for example, an insulating material, an organic material, and a solvent, and a sintering aid as desired.

The organic material (corresponding to a binding material) contained in the paste is not particularly limited, and at least one polymer material selected from the group consisting of a polyvinyl acetal resin, a cellulose resin, a polyacrylic resin, a polyurethane resin, a polyvinyl acetate resin, a polyvinyl alcohol resin, and the like can be used.

The type of the solvent is not particularly limited, and the solvent is, for example, any one, or two or more of organic solvents such as terpineol, butyl acetate, N-methyl-pyrrolidone, toluene, terpineol, and N-methyl-pyrrolidone.

In the wet mixing, a medium can be used, and specifically, a ball mill method, a Visco mill method, or the like can be used. On the other hand, a wet mixing method that does not use a medium may be used, and a sand mill method, a high-pressure homogenizer method, a kneader dispersion method, or the like can be used.

The supporting substrate is not particularly limited as long as the supporting substrate is a support that is capable of supporting each paste layer, and the supporting substrate is, for example, a release film that has one surface subjected to a release treatment, or the like. Specifically, a substrate formed from a polymer material such as a polyethylene terephthalate can be used. When the paste layer is subjected to a firing step with the paste layer held on the substrate, a substrate with heat resistance to the firing temperature may be used.

Alternatively, a solid-state battery laminate precursor can also be prepared by forming each green sheet from each of the pastes, and stacking the obtained green sheets.

Specifically, a supporting substrate with each paste applied thereto is dried on a hot plate heated to 30° C. or higher and 90° C. or lower to form, on each supporting substrate (for example, a PET film), each green sheet such as a positive electrode active material part green sheet, a negative electrode active material part green sheet, a solid electrolyte part green sheet, a positive electrode current collector green sheet, a negative electrode current collector green sheet, an electrode separating part green sheet, and/or an outer layer material green sheet, which has predetermined shape and thickness.

Next, each green sheet is peeled off from the substrate. After the peeling, the green sheets for respective constituent elements are sequentially stacked in the stacking direction to form a solid-state battery laminate precursor. At the time of stacking, the paste for an electrode enclosure part or the like may be applied to the side region of the electrode green sheet by screen printing and may be dried.

In either case, in the process of forming a solid-state battery laminate precursor, a green sheet for a positive electrode active material part is provided on the main surface of the solid electrolyte part green sheet, and the first paste containing a second solid electrolyte and the second paste containing a first solid electrolyte are applied by printing by screen printing so as to be in contact with the side surface of the green sheet for a positive electrode active material part.

The first paste is applied by printing between a portion where the external terminal on the negative electrode side to be disposed later can be installed on the main surface of the solid electrolyte part green sheet and the green sheet for a positive electrode active material part. The second paste is applied by printing on a portion on the side surface of the green sheet for a positive electrode active material part other than a portion where the external terminal on the positive electrode side to be disposed later can be disposed, so that the second paste is continuous with the first paste.

### (Degreasing Step and Firing Step)

In the firing step, the solid-state battery laminate precursor is subjected to firing. Although the followings are merely examples, firing is carried out by removing the organic material (corresponding to a binding material) by heating in a nitrogen gas atmosphere containing oxygen gas or in the atmosphere, for example, at 200° C. or higher, and then heating in the nitrogen gas atmosphere or in the atmosphere, for example, at 300° C. or higher. Firing may be carried out while pressurizing the solid-state battery laminate precursor in the stacking direction (in some cases, stacking direction and direction perpendicular to the stacking direction).

By undergoing the firing step, a solid-state battery laminate is formed, and a desired solid-state battery is finally obtained.

### (Step of Forming External Terminal on Positive Electrode Side and External Terminal on Negative Electrode Side)

For example, an external terminal on the positive electrode side is bonded to the solid-state battery laminate using a conductive adhesive, and an external terminal on the negative electrode side is bonded to the solid-state battery laminate using a conductive adhesive. Thereby, each of the external terminals on the positive electrode side and the external terminal on the negative electrode side is attached to the solid-state battery laminate. As a result, a desired solid-state battery can be finally obtained.

### EXAMPLES

Hereinafter, Examples will be described.

### Example 1-1

### (Step of Preparing Green Sheet for Solid Electrolyte Part)

First, lithium borosilicate glass was prepared as a solid electrolyte, an acrylic binder was prepared as a binder (binding material), and butyl acetate was prepared as a solvent. Specifically, as lithium borosilicate glass, one having a composition of Li₂O:SiO₂:B₂O₃=60:10:30 (mol % ratio) in which 10% of O (oxygen atoms) is substituted with Cl (corresponding to a first solid electrolyte α1) was used. Next, a mixing ratio (weight ratio) of the solid electrolyte and the electrolyte binder was set to 70:30, and mixing was performed so that the solid content concentration in the mixture was set to 30 wt %. This mixture was stirred with zirconia balls having a diameter of 5 mm for 4 hours to obtain a paste for a solid electrolyte part. Subsequently, this paste was applied onto a release film (manufactured by Toray Industries, Inc.) and dried at 80° C. for 10 minutes to prepare a green sheet for a solid electrolyte part as a solid electrolyte part precursor.

### (Step of Preparing Paste for Positive Electrode Active Material Part)

First, LiCoO₂ (corresponding to LCO) was prepared as a positive electrode active material, a solid electrolyte using a green sheet for a solid electrolyte part was prepared as a solid electrolyte, an acrylic binder was prepared as a binder (binding material), and terpineol was prepared as a solvent. Each ratio was adjusted to active material:solid electrolyte:binder=70:20:10 (wt %), and the solid content concentration was set to 60%. This mixture was stirred for 1 hour using a stirrer to prepare a paste for a positive electrode active material part.

### (Step of Preparing Paste for Negative Electrode Active Material Part)

First, graphite was prepared as a negative electrode active material, a solid electrolyte using a green sheet for a solid electrolyte part was prepared as a solid electrolyte, an acrylic binder was prepared as a binder (binding material), and terpineol was prepared as a solvent. Each ratio was adjusted to active material:solid electrolyte binder=70:20:10 (wt %), and the solid content concentration was set to 60%. This mixture was stirred for 1 hour using a stirrer to prepare a paste for a negative electrode active material part.

### (Step of Preparing Paste for Positive Electrode Current Collector)

First, a carbon material (manufactured by Resonac Holdings Corporation, Product No.: VGCF (registered trademark)-H) was prepared as a conductive material, a solid electrolyte using a green sheet for a solid electrolyte part was prepared as a solid electrolyte, an acrylic binder was prepared as a binder (binding material), and terpineol was prepared as a solvent. Each ratio was adjusted to carbon material:solid electrolyte:binder=70:20:10 (wt %), and the solid content concentration was set to 60%. This mixture was stirred for 1 hour using a stirrer to prepare a paste for a positive electrode current collector.

### (Step of Preparing Paste for Negative Electrode Current Collector)

A green sheet for a negative electrode current collector was prepared in the same manner as in the above-described step of preparing a green sheet for a positive electrode current collector.

### (Step of Preparing First Paste for Electrode Enclosure Part)

Next, alumina (manufactured by Kojundo Chemical Lab. Co., Ltd., Product No.: γ-Al₂O₃ Alumina) was prepared as an insulating material, halogen-free lithium borosilicate glass was prepared as a solid electrolyte, an acrylic binder was prepared as a binder (binding material), and terpineol was prepared as a solvent. Specifically, as lithium borosilicate glass, one having a composition of Li₂O:SiO₂:B₂O₃=60:10:30 (mol % ratio) and containing no halogen (corresponding to a second solid electrolyte (β1) was used. Each ratio was adjusted to insulating material:solid electrolyte:binder=70:20:10 (wt %), and the solid content concentration was set to 60%. This mixture was stirred for 1 hour using a stirrer to prepare a first paste for an electrode enclosure part.

### (Step of Preparing Second Paste for Electrode Enclosure Part)

Next, alumina (manufactured by Kojundo Chemical Lab. Co., Ltd., Product No.: γ-Alumina) was prepared as an insulating material, a solid electrolyte using a green sheet for a solid electrolyte part was prepared as a solid electrolyte, an acrylic binder was prepared as a binder (binding material), and terpineol was prepared as a solvent. Specifically, as lithium borosilicate glass, one having a composition of Li₂O:SiO₂:B₂O₃=60:10:30 (mol % ratio) and containing no halogen was used. Each ratio was adjusted to insulating material:solid electrolyte:binder=70:20:10 (wt %), and the solid content concentration was set to 60%. This mixture was stirred for 1 hour using a stirrer to prepare a second paste for an electrode enclosure part.

### (Step of Preparing Exterior Body Paste)

An exterior body paste was prepared through the same step as the step of preparing a second paste for an electrode enclosure part.

### (Step of Preparing Laminate)

The paste for a positive electrode active material part was applied to the main surface of the prepared electrolyte green sheet by using a screen printing method, and then dried at 80° C. to form a positive electrode active material part. The first paste for an electrode enclosure part was applied by printing using a screen printing method so as to be in contact with the side surface of the formed positive electrode active material part, and the second paste for an electrode enclosure part was continuously applied thereto by printing. The first paste for an electrode enclosure part was applied by printing so that the obtained first region of the electrode enclosure part occupied the range illustrated in FIG. 2A. The paste for a positive electrode current collector was applied by printing so as to cover the positive electrode active material part. These pastes were dried at 80° C. to prepare a green sheet of a positive electrode.

The paste for a negative electrode active material part was applied to the main surface of the prepared electrolyte green sheet by using a screen printing method, and then dried at 80° C. to form a negative electrode active material part. The second paste for an electrode enclosure part was applied by printing using a screen printing method so as to be in contact with the side surface of the formed negative electrode active material part. The paste for a negative electrode current collector was applied by printing so as to cover the negative electrode active material part. These pastes were dried at 80° C. to prepare a green sheet of a negative electrode.

Thereafter, the plurality of solid electrolyte green sheets prepared above were stacked, 13 negative electrode green sheets with a solid electrolyte green sheet and 12 positive electrode green sheets with a solid electrolyte green sheet which were prepared above were then alternately stacked, and a plurality of solid electrolyte green sheets were further stacked thereon. This laminate was heated to 100° C. while applying a pressure in the thickness direction to prepare a laminate in which each green sheet was pressure-bonded.

### (Step of Degreasing and Sintering Laminate)

The obtained laminate was heated at 300° C. for 10 hours to remove the acrylic binder contained in each green sheet, and then the degreased laminate was heated to 350° C. while applying a pressure in the thickness direction, was held for 10 minutes, and then was cooled to obtain a sintered laminate.

### (Step of Preparing External Terminal)

Thereafter, an external terminal on the positive electrode side was bonded to the sintered laminate using a conductive adhesive, and an external terminal on the negative electrode side was bonded thereto using a conductive adhesive. Thereby, each of the external terminals on the positive electrode side and the external terminal on the negative electrode side was attached to the sintered laminate. As described above, a desired solid-state battery can be obtained.

### Example 1-2

This example is different from Example 1-1 only in that a conductive adhesive is used as an external terminal material in the above-described step of preparing an external terminal.

### Example 1-3

As compared with Example 1-1, in the above-described step of preparing a first paste for an electrode enclosure part, as lithium borosilicate glass of a solid electrolyte, one having a composition of Li₂O:SiO₂:B₂O₃=60:10:30 (mol % ratio) in which 0.1% of oxygen atoms were substituted with halogen (corresponding to a second solid electrolyte β2) was used. In this case, the element ratio of halogen to lithium of the second solid electrolyte 32 was 0.14%.

### Example 1-4

As compared with Example 1-1, in the above-described step of preparing a first paste for an electrode enclosure part, as lithium borosilicate glass of a solid electrolyte, one having a composition of Li₂O:SiO₂:B₂O₃=60:10:30 (mol % ratio) in which 0.5% of oxygen atoms were substituted with halogen (corresponding to a second solid electrolyte β3) was used. In this case, the element ratio of halogen to lithium of the second solid electrolyte β3 was 0.71%.

### Example 1-5

As compared with Example 1-1, in the above-described step of preparing a first paste for an electrode enclosure part, as lithium borosilicate glass of a solid electrolyte, one having a composition of Li₂O:SiO₂:B₂O₃=60:10:30 (mol % ratio) in which 1% of oxygen atoms were substituted with halogen (corresponding to a second solid electrolyte β4) was used. In this case, the element ratio of halogen to lithium of the second solid electrolyte β4 was 1.42%.

### Example 1-6

As compared with Example 1-1, in the above-described step of preparing a first paste for an electrode enclosure part, as lithium borosilicate glass of a solid electrolyte, one having a composition of Li₂O:SiO₂:B₂O₃=60:10:30 (mol % ratio) in which 2% of oxygen atoms were substituted with halogen (corresponding to a second solid electrolyte β5) was used. In this case, the element ratio of halogen to lithium of the second solid electrolyte β5 was 2.83%.

### Comparative Example 1-1

As compared with Example 1-1, in the above-described step of preparing a first paste for an electrode enclosure part, as lithium borosilicate glass of a solid electrolyte, one having a composition of Li₂O:SiO₂:B₂O₃=60:10:30 (mol % ratio) in which 5% of oxygen atoms were substituted with halogen (corresponding to a first solid electrolyte α2) was used. In this case, the element ratio of halogen to lithium of the first solid electrolyte α2 was 7.08%.

### Comparative Example 1-2

As compared with Example 1-1, in the above-described step of preparing a first paste for an electrode enclosure part, as lithium borosilicate glass of a solid electrolyte, one having a composition of Li₂O:SiO₂:B₂O₃=60:10:30 (mol % ratio) in which 10% of oxygen atoms were substituted with halogen (corresponding to a first solid electrolyte α1) was used. In this case, the element ratio of halogen to lithium of the first solid electrolyte α1 used for the first paste for an electrode enclosure part was about 14%.

### Comparative Example 1-3

As compared with Example 1-1, in the above-described step of preparing a first paste for an electrode enclosure part, as lithium borosilicate glass of a solid electrolyte, one having a composition of Li₂O:SiO₂:B₂O₃=60:10:30 (mol % ratio) in which 10% of oxygen atoms were substituted with halogen (corresponding to a first solid electrolyte α1) was used. In this case, the element ratio of halogen to lithium of the first solid electrolyte α1 used for the first paste for an electrode enclosure part was about 14%. This example is different from Comparative Example 1-2 only in that a conductive adhesive is used as an external terminal material in the above-described step of preparing an external terminal.

### Comparative Example 1-4

This example is different from Example 1-1 only in that a carbon material is used as an external terminal material.

### Comparative Example 1-5

This example is different from Comparative Examples 1-2 and 1-3 only in that a carbon material is used as an external terminal material in the above-described step of preparing an external terminal.

### (Measurement Procedure)

The external terminal of the solid-state battery obtained above was connected to a lead wire for energization, and then the solid-state battery was charged and discharged under the following conditions in a high-temperature atmosphere at 105° C. Specifically, at the time of charging, the battery was charged at a current of 1.0 C until the voltage reached 4.2 V, and then further charged at a voltage of 4.2 V until the current reached 0.01 C. The battery was discharged at a current of 0.1 C until the voltage reached 2.0 V. Presence or absence of occurrence of short circuit was confirmed when charging and discharging were repeated 300 times, 500 times, and up to 1000 times.

### (Measurement Results)

The measurement results are shown in Table 1.

TABLE 1

| | | | | Element ratio of |
|---|---|---|---|---|
| | | Element ratio | | halogen to |
| | | of halogen to | | lithium in first |
| | | lithium of | | solid electrolyte |
| | First solid | first solid | First or second | or second solid |
| | electrolyte | electrolyte (*) | solid electrolyte | electrolyte |
| Example 1-1 | α1 | 0.1417 | β1 | 0.0000 |
| Example 1-2 | α1 | 0.1417 | β1 | 0.0000 |
| Example 1-3 | α1 | 0.1417 | β2 | 0.0014 |
| Example 1-4 | α1 | 0.1417 | β3 | 0.0071 |
| Example 1-5 | α1 | 0.1417 | β4 | 0.0142 |
| Example 1-6 | α1 | 0.1417 | β5 | 0.0283 |
| Comparative | α1 | 0.1417 | α2 | 0.0708 |
| Example 1-1 | | | | |
| Comparative | α1 | 0.1417 | α1 | 0.1417 |
| Example 1-2 | | | | |
| Comparative | α1 | 0.1417 | α1 | 0.1417 |
| Example 1-3 | | | | |
| Comparative | α1 | 0.1417 | β1 | 0.0000 |
| Example 1-4 | | | | |
| Comparative | α1 | 0.1417 | α1 | 0.1417 |
| Example 1-5 | | | | |

* Ratio of element amount at predetermined site in solid electrolyte using XRF measurement method

| | Conductive material of | | | |
|---|---|---|---|---|
| | external terminal on | 105° C. short circuit detection test | | |
| | negative electrode side | 300 Cy | 500 Cy | 1000 Cy |
| Example 1-1 | Ag | ◯ | ◯ | ◯ |
| Example 1-2 | Cu | ◯ | ◯ | ◯ |
| Example 1-3 | Ag | ◯ | ◯ | ◯ |
| Example 1-4 | Ag | ◯ | ◯ | X |
| Example 1-5 | Ag | ◯ | X | X |
| Example 1-6 | Ag | ◯ | X | X |
| Comparative | Ag | X | X | X |
| Example 1-1 | | | | |
| Comparative | Ag | X | X | X |
| Example 1-2 | | | | |
| Comparative | Cu | X | X | X |
| Example 1-3 | | | | |
| Comparative | C | ◯ | ◯ | ◯ |
| Example 1-4 | | | | |
| Comparative | C | ◯ | ◯ | ◯ |
| Example 1-5 | | | | |

◯: Without short circuit
X: With short circuit

As can be seen from Table 1, FIG. 2A, and the like, in a case where the external terminal on the negative electrode side contained metal ions (silver ions/copper ions), when the element ratio of halogen to lithium of the second solid electrolytes (β1 to β5) in the first region interposed between the positive electrode active material part and the external terminal on the negative electrode side in the electrode enclosure part of the positive electrode was 0% to 6%, it could be confirmed that no short circuit occurred until 300 times of charging and discharging.

When the element ratio of halogen to lithium of the second solid electrolytes β1 to β3 in the first region of the electrode enclosure part described above was 0% to 1.3%, it could be confirmed that no short circuit occurred until 300 times and 500 times of charging and discharging. When the element ratio of the second solid electrolytes β1 and β2 in the first region of the electrode enclosure part described above was 0% to 0.6%, it could be confirmed that no short circuit occurred in any of 300 times, 500 times, and 1000 times of charging and discharging.

### Example 2-1

Example 2-1 corresponds to Example 1-1 described above.

### Example 2-2

Example 2-2 is different from Example 2-1 described above only in that, in the above-described step of preparing a laminate, the first paste for an electrode enclosure part was applied by printing by a screen printing method so that the obtained first region of the electrode enclosure part occupies the range illustrated in FIG. 2B.

### Example 2-3

Example 2-3 is different from Example 2-1 described above only in that, in the above-described step of preparing a laminate, the width of the first paste for an electrode enclosure part applied by printing in the X direction by a screen printing method is half, and the first region was disposed at a position where the first region can come into contact with the external terminal on the negative electrode side to be formed later.

### Example 2-4

Example 2-4 is different from Example 2-1 described above only in that, in the above-described step of preparing a laminate, the width to be applied by printing in the X direction by a screen printing method is half, and the external terminal on the negative electrode side to be disposed later faces away from any direction of the positive electrode active material part.

### Example 2-5

In Example 2-5, as compared with Example 2-1 described above, in the above-described step of preparing a first paste for an electrode enclosure part, as lithium borosilicate glass of a solid electrolyte, one having a composition of Li₂O:SiO₂:B₂O₃=60:10:30 (mol % ratio) in which 0.5% of oxygen atoms were substituted with halogen (corresponding to a second solid electrolyte β3) was used. In this case, the element ratio of halogen to lithium of the second solid electrolyte β3 was 0.71%.

### Example 2-6

Example 2-6 is different from Example 2-1 described above only in that, in the above-described step of preparing a laminate, the width of the first paste for an electrode enclosure part applied by printing in the X direction by a screen printing method is half, and the first region was disposed at a position where the first region can come into contact with the positive electrode active material part paste.

### Example 2-7

Example 2-7 is different from Example 2-1 described above only in that, in the above-described step of preparing a laminate, the width of the first paste for an electrode enclosure part applied by printing in the X direction by a screen printing method is ¾, and the first region was disposed at a position where the first region can come into contact with the external terminal on the negative electrode side to be formed later.

### Example 2-8

Example 2-8 is different from Example 2-1 described above in that, in the above-described step of preparing a laminate, the width of the first paste for an electrode enclosure part applied by printing in the X direction by a screen printing method is half, and the first region was disposed at a position where the first region can come into contact with the positive electrode active material part paste. In Example 2-8, as compared with Example 2-1 described above, in the above-described step of preparing a first paste for an electrode enclosure part, as lithium borosilicate glass of a solid electrolyte, one having a composition of Li₂O:SiO₂:B₂O₃=60:10:30 (mol % ratio) in which 0.5% of oxygen atoms were substituted with halogen (corresponding to a second solid electrolyte β3) was used. In this case, the element ratio of halogen to lithium of the second solid electrolyte β3 was 0.71%.

### Example 2-9

Example 2-9 is different from Example 2-1 described above in that, in the above-described step of preparing a laminate, the width of the first paste for an electrode enclosure part applied by printing in the X direction by a screen printing method is ¾, and the first region was disposed at a position where the first region can come into contact with the positive electrode active material part paste. In Example 2-9, as compared with Example 2-1 described above, in the above-described step of preparing a first paste for an electrode enclosure part, as lithium borosilicate glass of a solid electrolyte, one having a composition of Li₂O:SiO₂:B₂O₃=60:10:30 (mol % ratio) in which 0.5% of oxygen atoms were substituted with halogen (corresponding to a second solid electrolyte β3) was used. In this case, the element ratio of halogen to lithium of the second solid electrolyte β3 was 0.71%.

### Comparative Example 2-1

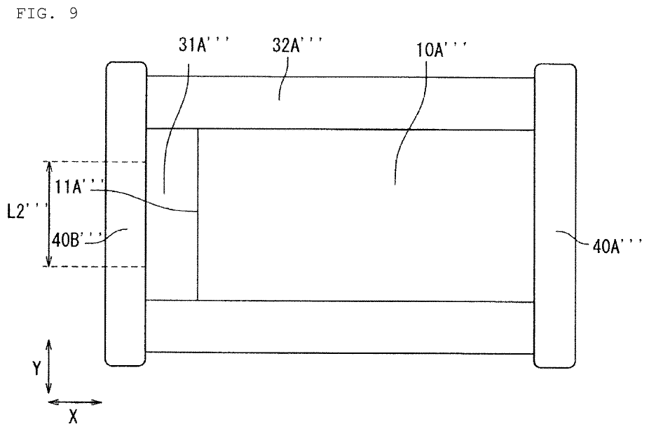

Comparative Example 2-1 is different from Example 2-1 described above only in that the first paste for an electrode enclosure part is applied by printing so as to have the same width as the width of the first outer edge of the portion serving as the positive electrode active material part in the Y direction (see FIG. 9).

### Comparative Example 2-2

Comparative Example 2-2 is different from Example 2-1 described above only in that the first paste for an electrode enclosure part is applied by printing so as to have a width less than the width of the first outer edge of the portion serving as the positive electrode active material part in the Y direction.

### Comparative Example 2-3

Comparative Example 2-3 is different from Example 2-1 described above in that, in the above-described step of preparing a laminate, the width of the first paste for an electrode enclosure part applied by printing in the X direction by a screen printing method is ¼, and the first region was disposed at a position where the first region can come into contact with the positive electrode active material part paste. In Comparative Example 2-3, as compared with Example 2-1 described above, in the above-described step of preparing a first paste for an electrode enclosure part, as lithium borosilicate glass of a solid electrolyte, one having a composition of Li₂O:SiO₂:B₂O₃=60:10:30 (mol % ratio) in which 0.5% of oxygen atoms were substituted with halogen (corresponding to a second solid electrolyte β3) was used. In this case, the element ratio of halogen to lithium of the second solid electrolyte β3 was 0.71%.

### (Measurement Procedure)

The external terminal of the solid-state battery obtained above was connected to a lead wire for energization, and then the solid-state battery was charged and discharged under the following conditions in a high-temperature atmosphere at 105° C. Specifically, at the time of charging, the battery was charged at a current of 1.0 C until the voltage reached 4.2 V, and then further charged at a voltage of 4.2 V until the current reached 0.01 C. The battery was discharged at a current of 0.1 C until the voltage reached 2.0 V. Presence or absence of occurrence of short circuit was confirmed when charging and discharging were repeated 300 times, 500 times, and up to 1000 times.

### (Measurement Results)

The measurement results are shown in Table 2.

TABLE 2

| | | Element | | Element | Arrangement |
|---|---|---|---|---|---|
| | | ratio of | | ratio of | mode of |
| | | halogen to | | halogen to | first |
| | | lithium of | | lithium of | region of |
| | | first solid | | second solid | electrode |
| | First solid | electrolyte | Second solid | electrolyte | enclosure |
| | electrolyte | (*) | electrolyte | (*) | part |
| Example 2-1 | α1 | 0.1417 | β1 | 0.0000 | FIG. 2A |
| Example 2-2 | α1 | 0.1417 | β1 | 0.0000 | FIG. 2B |
| Example 2-3 | α1 | 0.1417 | β1 | 0.0000 | FIG. 3 |
| Example 2-4 | α1 | 0.1417 | β1 | 0.0000 | FIG. 4 |
| Example 2-5 | α1 | 0.1417 | β3 | 0.0071 | FIG. 2A |
| Example 2-6 | α1 | 0.1417 | β1 | 0.0000 | FIG. 5 |
| Example 2-7 | α1 | 0.1417 | β1 | 0.0000 | FIG. 6 |
| Example 2-8 | α1 | 0.1417 | β3 | 0.0071 | FIG. 3 |
| Example 2-9 | α1 | 0.1417 | β3 | 0.0071 | FIG. 6 |
| Comparative | α1 | 0.1417 | β1 | 0.0000 | FIG. 9 |
| Example 2-1 | | | | | |
| Comparative | α1 | 0.1417 | β1 | 0.0000 | FIG. 7 |
| Example 2-2 | | | | | |
| Comparative | α1 | 0.1417 | β3 | 0.0071 | FIG. 8 |
| Example 2-3 | | | | | |

* Ratio of element amount at predetermined site in solid electrolyte using XRF measurement method

| | | | Conductive | | | |
|---|---|---|---|---|---|---|
| | Ratio | | material of | | | |
| | L3/L of | | external | | | |
| | width of | | terminal on | | | |
| | first | Width of | negative | | | |
| | region (X | first region | electrode | 105° C. short circuit detection test | | |
| | direction) | (Y direction) | side | 300 Cy | 500 Cy | 1000 Cy |
| Example 2-1 | 1 | Equal to battery | Ag | ◯ | ◯ | ◯ |
| | | element width | | | | |
| Example 2-2 | 1 | Equal to battery | Ag | ◯ | ◯ | ◯ |
| | | element width | | | | |
| Example 2-3 | ½ | Equal to battery | Ag | ◯ | ◯ | ◯ |
| | | element width | | | | |
| Example 2-4 | ½ | Equal to battery | Ag | ◯ | ◯ | ◯ |
| | | element width | | | | |
| Example 2-5 | 1 | Equal to battery | Ag | ◯ | ◯ | X |
| | | element width | | | | |
| Example 2-6 | ½ | Equal to battery | Ag | ◯ | ◯ | X |
| | | element width | | | | |
| Example 2-7 | ¾ | Equal to battery | Ag | ◯ | ◯ | ◯ |
| | | element width | | | | |
| Example 2-8 | ½ | Equal to battery | Ag | ◯ | ◯ | X |
| | | element width | | | | |
| Example 2-9 | ¾ | Equal to battery | Ag | ◯ | ◯ | X |
| | | element width | | | | |
| Comparative | 1 | Equal to first | Ag | X | X | X |
| Example 2-1 | | outer edge | | | | |
| | | width of | | | | |
| | | positive | | | | |
| | | electrode | | | | |
| | | layer | | | | |
| Comparative | 1 | Less than | Ag | X | X | X |
| Example 2-2 | | first outer | | | | |
| | | edge width of | | | | |
| | | positive | | | | |
| | | electrode | | | | |
| | | layer | | | | |
| Comparative | ¼ | Equal to battery | Ag | X | X | X |
| Example 2-3 | | element width | | | | |

◯: Without short circuit
X: With short circuit

As can be seen from Table 2 and the corresponding drawings shown in Table 2, in plan view, the first region of the electrode enclosure part of the obtained solid-state battery requires a first length longer than ¼ of a separation distance between the external terminal on the negative electrode side and the first outer edge of the positive electrode active material part in the first direction between the external terminals on the positive electrode side and on the negative electrode side, and a second length equal to the length of the battery element in the second direction intersecting the first direction. It was found that, in plan view, the first region is in contact with the first outer edge of the positive electrode active material part in the first direction and requires a second length longer than a length of the first outer edge of the positive electrode active material part in the second direction.

While an embodiment of the present disclosure has been described above, a typical example in the applicable scope of the present disclosure has been merely provided. Therefore, a person skilled in the art may easily understand that the present disclosure is not limited thereto, and various modifications may be made.

The solid-state battery according to an embodiment of the present disclosure can be used in various fields in which power storage is expected. By way of example only, the solid-state battery according to an embodiment of the present disclosure can be used in electric, information, and communication fields (for example, the fields of mobile devices such as cellular phones, smartphones, smartwatches, laptop computers, digital cameras, activity meters, arm computers, and electronic papers) in which a mobile device or the like is used, home and small-size industrial applications (for example, the fields of electric tools, golf carts, and domestic, nursing care, and industrial robots), large-size industrial applications (for example, the fields of forklifts, elevators, harbor cranes), transportation system fields (for example, fields such as hybrid vehicles, electric vehicles, buses, trains, power-assisted bicycles, and electric motorcycles), electric power system applications (for example, fields such as various types of electric power generation, load conditioners, smart grids, general household installation-type power storage systems), medical applications (fields of medical device such as earphone hearing aids), pharmaceutical applications (fields such as dosage management systems), IoT fields, space and deep-sea applications (for example, fields such as spacecraft and submersible research vehicles), and the like.

### DESCRIPTION OF REFERENCE SYMBOLS

200: Solid-state battery
100: Battery element
60: Exterior body
40A, 40B: External terminal
30A: Electrode enclosure part
31A: First region of electrode enclosure part
32A: Second region of electrode enclosure part
20: Solid electrolyte part
10A: Positive electrode active material part
10B: Negative electrode active material part

1. A solid-state battery comprising:
a battery element including:
a positive electrode including a positive electrode active material part;
a negative electrode including a negative electrode active material part;
a solid electrolyte part interposed between the positive electrode and the negative electrode; and
a positive external terminal in contact with the positive electrode; and
a negative external terminal in contact with the negative electrode, wherein
the battery element further includes:
a first electrode enclosure part surrounding a portion other than a first contact portion between the positive external terminal and the positive electrode in a plan view as viewed from a thickness direction of the battery element; and
a second electrode enclosure part surrounding a portion other than a second contact portion between the negative external terminal and the negative electrode in the plan view as viewed from the thickness direction of the battery element,
the negative external terminal contains a metal component,
at least the positive electrode contains a first solid electrolyte containing lithium and halogen,
the first electrode enclosure part includes at least a first region interposed between the positive electrode and the negative external terminal,
the first region contains lithium and a second solid electrolyte containing halogen or not containing halogen, and an element ratio (%) of halogen to the lithium of the second solid electrolyte in the first region is 0% to 6%,
the positive electrode includes a first outer edge facing away from the negative external terminal with the first region interposed therebetween,
(i) in the plan view, the first region has a first length longer than ¼ of a separation distance between the negative external terminal and the first outer edge of the positive electrode active material part in a first direction between the positive external terminal and the negative external terminal, and has a second length equal to a length of the battery element in a second direction intersecting the first direction, and/or
(ii) in the plan view, the first region is in contact with at least the first outer edge of the positive electrode active material part in the first direction, and has a second length longer than a length of the first outer edge of the positive electrode active material part in the second direction.

2. The solid-state battery according to claim 1, wherein the element ratio of the second solid electrolyte in the first region of the electrode enclosure part is 0% to 3%.

3. The solid-state battery according to claim 1, wherein the element ratio of the second solid electrolyte in the first region of the electrode enclosure part is 0% to 1.3%.

4. The solid-state battery according to claim 1, wherein the element ratio of the second solid electrolyte in the first region of the electrode enclosure part is 0% to 0.6%.

5. The solid-state battery according to claim 1, wherein, in the (i), the first length of the first region of the electrode enclosure part is ½ or more of the separation distance between the negative external terminal and the first outer edge of the positive electrode active material part.

6. The solid-state battery according to claim 1, wherein, in the (i), in the plan view, the first region of the electrode enclosure part is in contact with at least one of the positive electrode active material part and the negative external terminal.

7. The solid-state battery according to claim 1, wherein, in the (ii), the first region has a first length equal to the separation distance between the negative external terminal and the first outer edge of the positive electrode active material part in the first direction.

8. The solid-state battery according to claim 7, wherein, in the (ii), in the plan view, the second length of the first region is equal to a length of the battery element in the second direction.

9. The solid-state battery according to claim 1, wherein, in the (ii), in the plan view, the second length of the first region is equal to a length of the battery element in the second direction.

10. The solid-state battery according to claim 1, wherein, in the plan view, the first electrode enclosure part includes the first region and a second region continuous with the first region and containing the first solid electrolyte.

11. The solid-state battery according to claim 1, wherein, in the plan view, the positive electrode active material part has a rectangular shape and includes the first outer edge and second and third outer edges continuous with the first outer edge and extending in a direction intersecting an extending direction of the first outer edge, and the first region of the electrode enclosure part further faces the second and third outer edges in addition to the first outer edge.

12. The solid-state battery according to claim 1, wherein each of the first solid electrolyte and the second solid electrolyte is an oxide glass-based solid electrolyte.

13. The solid-state battery according to claim 12, wherein the oxide glass-based solid electrolyte contains lithium borosilicate glass as a main component.

14. The solid-state battery according to claim 1, wherein the metal component of the negative external terminal includes at least one metal element selected from the group consisting of Ag, Cu, and Ni.

15. The solid-state battery according to claim 1, wherein the first region of the electrode enclosure part is a prevention region of ion migration of the metal component of the negative external terminal toward the positive electrode active material part.

16. The solid-state battery according to claim 1, wherein the negative electrode active material part and the solid electrolyte part contain the first solid electrolyte.

17. The solid-state battery according to claim 1, wherein the positive electrode active material of the positive electrode active material part contains a lithium-containing layered oxide.

18. The solid-state battery according to claim 1, wherein the positive electrode active material part and the negative electrode active material part are regions capable of storing and releasing lithium ions.
